(19) United States
(12) Patent Application Publication
(10) Pub. No.: US 2009/0199941 A1
(43) Pub. Date: Aug. 13, 2009

(54) Combination Wallet Tool

(75) Inventors: James Carl Toner, Morganton, NC (US); Garry Brandon Hensley, Morganton, NC (US)

Correspondence Address: SHOEMAKER AND MATTARE, LTD, 10 POST OFFICE ROAD - SUITE 100, SILVER SPRING, MD, 20910, US

(73) Assignee: TONER MACHINING TECHNOLOGIES, INC., Morganton, NC (US)

(21) Appl. No.: 12/030,456

(22) Filed: Feb. 13, 2008

(51) Int. Cl. A45C 1/06; B65D 71/00; B65D 69/00; B25F 1/00; B26B 11/00; A45C 11/00

(52) U.S. Cl. 150/143; 7/118; 206/38; 206/38.1; 206/234

(57) ABSTRACT

A combination wallet tool includes a pair of hinged, mating shells which define a closed chamber when closed and latched. The chamber is partitioned to provide areas in which currency, cards and papers may be kept. The mating surfaces of the shells are sealed, for example, by an O-ring to keep water from entering the chamber. A variety of useful tools having identical bases may be interchangeably seated in respective apertures provided in the shells.

### BACKGROUND OF THE INVENTION

This invention relates to a combination wallet and tool kit.

### SUMMARY OF THE INVENTION

An object of the invention is to provide a robust, durable, waterproof wallet having not only a compartment for cash, cards and papers, but also a number of removable or deployable tools such as tweezers, a knife, a key holder or the like.

These and other objects are attained by a combination wallet tool as described below.

The invention provides all in one multi-tool functionality, integrated into a wallet. The wallet allows users to incorporate various sets of tools, implements, and attachments in a portable, compact, and waterproof case. The basic wallet may a have built in compass, safety mirror, fire-starter/magnifying glass, lanyard location, and storage for four tools and could be later expanded to more tools. Internally, the wallet has structure defining positions for cash in a money clip folded fashion, and credit cards/business cards.

### BRIEF DESCRIPTION OF THE DRAWINGS

In the accompanying drawings,

FIG. 1 is an exploded isometric view of a combination wallet tool embodying the invention, showing the outside surfaces of the open wallet;

FIG. 2 is an isometric view showing the inside surfaces of the open wallet;

FIG. 3 is an isometric view of the wallet when closed;

FIG. 4 is a sectional view of a portion of the wallet.

### DESCRIPTION OF THE PREFERRED EMBODIMENT

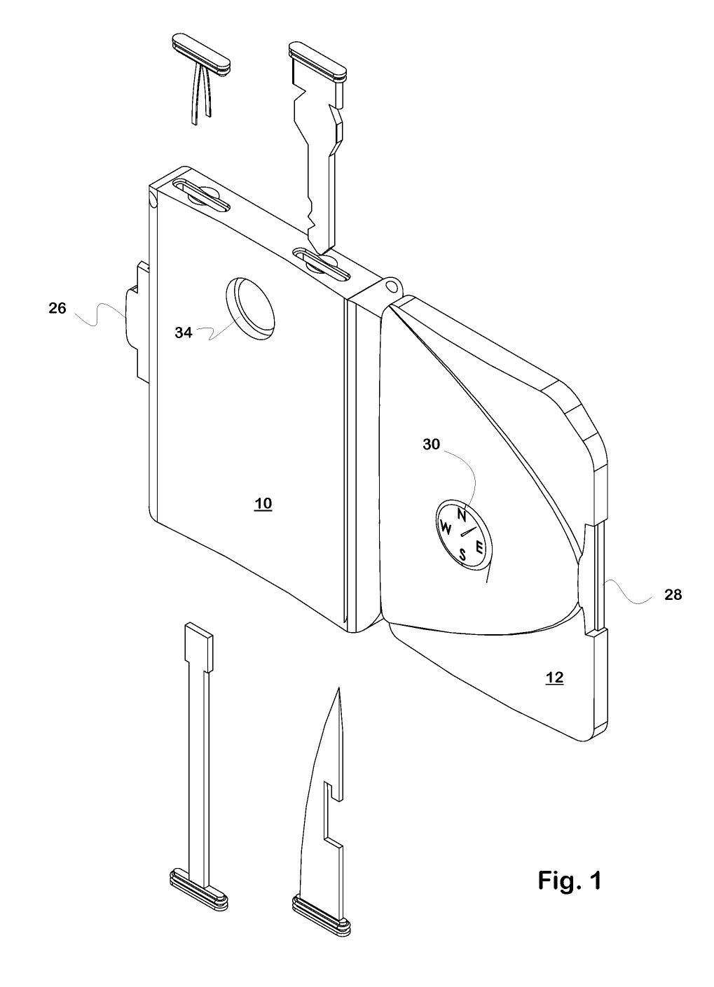

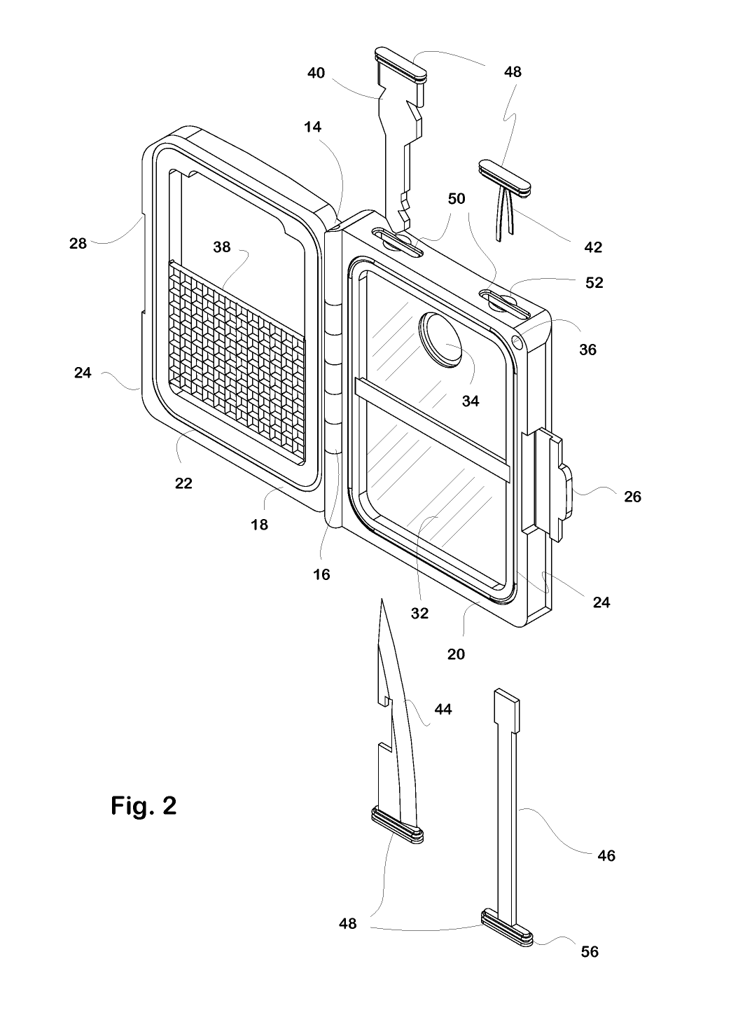

A combination wallet tool embodying the invention includes, as shown in FIGS. 1 and 2, two shells 10 and 12 which are interconnected by a hinge pin 14 (FIG. 2) passing through holes in protrusions 16 on either part. The mechanical hinge shown might be replaced with a molded “living” hinge as an alternative.

The wallet shells may be made of plastic, metal (e.g., aluminum or titanium) and/or wood. Details of the wallet's manufacturing will be based on the material(s) selected. For example, if plastic is used, the shells could be injection molded in two pieces (or as a single piece including a “living” hinge) with an insert for the floor of the money clip side. Metal and wood versions may be manufactured as two pieces with an insert for the floor of the money clip side.

Regardless of the material chosen, it is contemplated that the overall dimensions of the wallet will be roughly the size of a man's conventional pocket wallet.

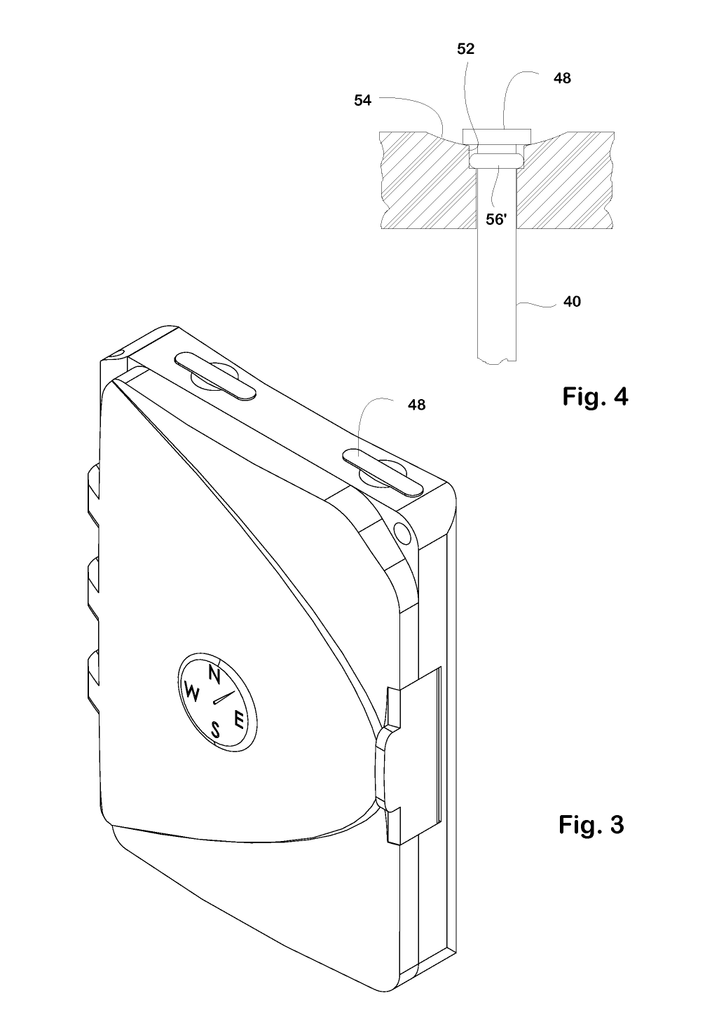

The shells 10 and 12 have planar mating surfaces 18, 20 which meet when the wallet is closed (FIG. 3). At least one of the planar surfaces has a peripheral groove 22 for receiving a resilient sealing element such as an O-ring 24. At least one of the shells has a central recess surrounded by the planar mating surface so that when the wallet is closed, the components define and interior cavity protected from moisture by the sealing element.

The shells are normally held together by a latch mechanism designed to insure waterproof sealing and prevent unexpected opening. Various type of latches might be used; a presently preferred latch is illustrated. It comprises structures 26, 28 molded into the respective components on the edges opposite the hinged edges. The latch components might, alternatively, be made separate from the wallet shells, and it is also possible that a non-mechanical latch such as a strong magnetic latch might be substituted.

In the preferred form of the invention, both of the shells of the wallet are centrally recessed. A compass 30, a mirror 32, a fire-starter/magnifying glass 34, and a lanyard hole 36 are built into one shell or the other. At least one shell has a partition 38 defining a space for currency, cards and papers. The partition may be rigid, or it may be a flexible mesh panel as illustrated.

The types of tools which may be made and used with this invention are unlimited. Likely examples, illustrated, are a key holder 40, tweezers 42, a knife/can opener 44 and a screwdriver 46. Each tool is made to include a specialized waterproof base 48 that seats neatly in one of the manufactured apertures 50 in the shells, preventing entry of water and securing the tool. The bases preferably are identical so that the tools can be interchanged or replaced by others having the same standard base.

The body of each tool made for this invention must be narrow enough to be inserted through one of the apertures, into the recessed interior of the wallet. The standard base has a cross-section at least as large at, preferably larger than, the rest of the tool, so that the tool, but not the base, can pass through the aperture.

We presently prefer that the apertures be undercut (see FIG. 4) with heir larger portion facing to the outside of the wallet. The undercut 52 defines a step at the bottom of the aperture which acts as a stop to prevent the base 48 from being pushed all the way through the aperture. A depression 54 is formed in the wallet shell at the top of each undercut, to enable a person to grasp the head of a tool, which sits almost flush with the top of the shell.

The aperture and/or the base preferably have a sealing structure to prevent ambient water from entering the wallet through the apertures. The sealing structure illustrated in FIG. 2 is an O-ring 56 seated in a groove on the base; the O-ring bears against the wall of the undercut aperture 50 when the base is fully seated. Alternative sealing means, such as a flexible rib 56′ (FIG. 4) integrally molded on one of the components, might be substituted. Another alternative would be to provide matching slight taper angles on both the apertures and the bases, in which case the undercut would not be necessary and wedging between the base and the aperture would provide both a stop function and sealing.

A further possibility is that the apertures might have neither a taper nor an undercut. This would permit one to remove a tool such as the screwdriver from its stowed position and reseat it backwards in the aperture, with the blade outside of the wallet. Then the wallet body would function as a handle. However, the stopping function of the undercut or taper would be lost and some other way of retaining the tools securely would have to be devised.

The interchangeability of the tools of this invention gives the wallet some of functionality of a ‘Swiss Army’ knife, and in addition permits the owner to replace one set of tools with another. For example, he or she might ordinarily carry tools useful at the office, and then swap them out for tools useful for fishing on the weekend.

Since invention is subject to modifications and variations, it is intended that the foregoing description and the accompanying drawings shall be interpreted as only illustrative of the invention defined by the following claims.

I claim:

1. A combination wallet tool comprising
a pair of mating shells interconnected by a hinge so as to be movable between an open configuration and a closed configuration in which the shells define a closed chamber,
a latch for holding the shells together when the wallet is closed, and
means for sealing the interface between the shells when the wallet is latched closed, to keep water from entering the chamber,
at least one of the shells having a plurality of apertures therein, each aperture serving as a recess in which one of a number of interchangeable tools may be seated,
the apertures being substantially identical in cross-section.

2. The invention of claim 1, further comprising a number of interchangeable tools sufficient to occupy each of said apertures.

3. The invention of claim 2, wherein at least some of said tools are selected from the group consisting of knife, can opener, key holder, tweezer and screwdriver.

4. The invention of claim 2, wherein each said tool has a base sized to seat in one of said apertures, the base having a cross-section greater than that of the rest of the tool so that the tool can be inserted through the aperture into the wallet from outside the wallet.

5. The invention of claim 4, wherein each of the apertures is undercut from outside the wallet, forming a step which stops the base of the tool when the tool is inserted into the aperture.

6. The invention of claim 5, wherein the undercut and the base are dimensioned so that a portion of the base remains protruding from the wallet when the tool is fully seated, whereby one can grasp the protruding portion to remove the tool.

7. The invention of claim 4, further comprising means for sealing the base of the tool against the aperture to prevent ingress of water.

8. The invention of claim 7, wherein the sealing means is an O-ring or rib on one or both of the aperture and the tool base.
